(19) United States
(12) Patent Application Publication
(10) Pub. No.: US 2018/0314799 A1
(43) Pub. Date: Nov. 1, 2018

(54) System and Method for Linking Home Health Agencies and Health Care Providers over a Network

(71) Applicant: D&J Healthcare Holdings, LLC, Austin, TX (US)

(72) Inventor: Daniel Silver, Austin, TX (US)

(21) Appl. No.: 15/498,485

(22) Filed: Apr. 27, 2017

(51) Int. Cl. G06F 19/00; G06Q 10/10

(52) U.S. Cl. CPC G06F 19/322; G06F 19/327; G06Q 10/1053

(57) ABSTRACT

A system and method for linking home health agencies and health care providers over a network can comprise the steps of storing a home health agency (HHA) profile, storing a plurality of healthcare provider (HCP) profiles, and receiving and storing a job record within a data store. The HHA profile can be accessible by an HHA via a server. Each of the HCP profiles can be associated with an HCP. The job record can be created by the HHA logged in to the HHA profile. The step can comprise displaying on a map an icon related to the job record. The icon can be visible to a first HCP logged into a first HCP profile of the plurality of HCP profiles. The step can also comprise displaying, at least a portion of the job record and an option to accept responsibility for the treatment request. Additionally, the step can comprise transmitting to a second HCP a second option to accept responsibility for said treatment request. Lastly, the method can comprise linking the job record to the first HCP profile and the second HCP profile after the first HCP and the second HCP both accept responsibility for said treatment request.

### BACKGROUND

This disclosure relates to a system and method for linking home health agencies (HHAs) and health care providers (HCPs) over a network.

As our population ages, there is an ever-increasing need for home health care services especially for aged patients. These patients often favor home health care services so they can continue to live independently while receiving their needed treatments within the comfort of their home. Seniors can either seek an independent health care provider or work with a home health agency although in most cases the patient's doctor or hospital can make arrangements for the aged patient's home health care. Patients with debilitating injuries are also often in need of home care. In a typical scenario, to receive home health care, a patient will first see a doctor who will prescribe such home health care. A doctor will refer to the patient to an HHA, and the HHA will facilitate the care, either using employees of the HHA, or by contracting the care out to contractors. However, it can be difficult at times for an HHA to find quality HCPs to service each patient in need. HHAs have difficulty covering areas for physical therapy, occupational therapy, speech therapy and nursing due to lack of manpower and hard-to-cover areas, which causes them to contract others for coverage. If the HHA cannot provide service itself and also cannot find a contractor to provide the service, the HHA will turn the patient away. Three problems an HHA encounters relating to its ability to service patients are the geographic location of the patients, response times of HCPs assisting patients, and staffing HCPs. As such, it would be useful to have a system and method capable of connecting HHAs with HCPs in geographic proximity to patients, over a network.

### SUMMARY

A system and method for linking home health agencies and health care providers over a network is herein disclosed. The method can comprise the steps of storing a home health agency (HHA) profile, storing a plurality of healthcare provider (HCP) profiles, and receiving and storing a job record within a data store. The HHA profile can be accessible by a server. Further the HHA profile can be accessible by an HHA. Each of the HCP profiles can be associated with an HCP. The job record can be created by the HHA logged in to the HHA profile. The job record can be linked to the HHA profile within the data store. Further, the job record can comprise patient biographic data, a treatment request, and geographic location related to an anticipated location of treatment. Moreover the step can comprise displaying on a map an icon related to the job record, the location of the icon on the map is proximate to the geographic location. The icon can be visible to a first HCP logged into a first HCP profile of the plurality of HCP profiles. The icon can be selectable by the first HCP. The step can also comprise displaying, upon selection of the icon by the first HCP, at least a portion of the job record and an option to accept responsibility for the treatment request. Additionally, the step can comprise transmitting to a second HCP via one of a second HCP profile of the plurality of HCP profiles a second option to accept responsibility for said treatment request. Lastly, the method can comprise linking the job record to the first HCP profile and the second HCP profile after the first HCP and the second HCP both accept responsibility for said treatment request.

In another embodiment, a system for linking home health agencies and health care providers over a network is herein disclosed. The system can comprise a server memory, and a server processor. The server memory can store a home health agency (HHA) profile, one or more primary healthcare provider (PHCP) profiles, one or more patient records, one or more job records, and a server application. The HHA profile can be accessible by a server. Further the HHA profile can be accessible by an HHA. Each of the HCP profiles can be associated with an HCP. The job record can be created by the HHA logged into the HHA profile. The job record can be linked to the HHA profile. Further, the job record can comprise patient biographic data, a treatment request, and geographic location related to an anticipated location of treatment. The server processor that, according to the instructions from the server application displays on a map an icon related to one of the job records. The location of the icon on the map is proximate to the geographic location. The icon can be visible to a first HCP logged into a first HCP profile of the plurality of HCP profiles. The icon can be selectable by the first HCP. Additionally, according to the instructions from the server application displays, upon selection of the icon by the first HCP, at least a portion of the one of the job records and an option to accept responsibility for the treatment request. Lastly, according to the instructions from the server application, transmits to a second HCP via one of a second HCP profile of the plurality of HCP profiles a second option to accept responsibility for the treatment request; And links the one of the job records to the first HCP profile and the second HCP profile after the first HCP and the second HCP both accept responsibility for the treatment request.

Lastly, a non-transitory computer readable storage medium having a computer readable program code embodied therein, wherein the computer readable program code is adapted to be executed to implement the above mentioned method.

### BRIEF DESCRIPTION OF THE DRAWINGS

FIG. 1 illustrates a home health agency (HHA) and health care provider (HCP) linking system.

FIG. 2 illustrates a schematic diagram of a home health agency server.

FIG. 3 illustrates data storage.

FIG. 4A illustrates a home health agency (HHA) profile.

FIG. 4B illustrates a primary health care provider (PHCP) profile.

FIG. 4C illustrates an assistant health care provider (AHCP) profile.

FIG. 4D illustrates a job record.

FIG. 5 illustrates an embodiment of a home health agency (HHA) home screen.

FIG. 6 illustrates an embodiment of a home health agency (HHA) jobs screen.

FIG. 7 illustrates an embodiment of a home health agency (HHA) providers screen.

FIG. 8 illustrates an embodiment of a primary health care provider (PHCP) home screen.

FIG. 9 illustrates an embodiment of a primary health care provider (PHCP) job screen.

FIG. 10 illustrates an embodiment of an assistant health care provider (AHCP) jobs screen.

FIG. 11 illustrates an embodiment of an add job screen.

FIG. 12 illustrates an embodiment of a system map.

FIG. 13 illustrates an embodiment of a system map as viewed by an assistant health care provider (AHCP) user.

FIG. 14 illustrates treatment information of job record viewable by users of the linking system.

FIG. 15 illustrates an exemplary method.

### DETAILED DESCRIPTION

Described herein is a system and method for linking home health agencies (HHAs) and health care providers (HCPs) over a network. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

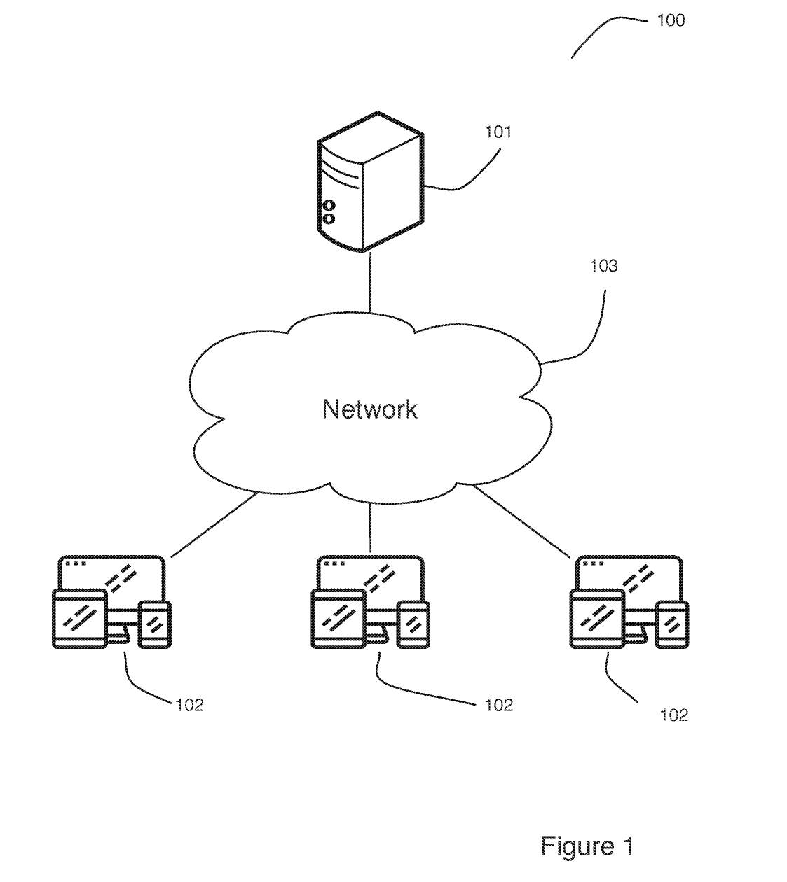

FIG. 1 illustrates a home health agency (HHA) and health care provider (HCP) linking system 100 comprising a server 101 connected to one or more computers 102 through a network 103. Server 101 represents at least one, but can be many servers, each connected to network 103 capable of performing computational task, and storing data information. Server 101 can be accessible to an individual or an institution through a web browser on computers 102, or through a standalone application running on computer 102 such as a desktop application or mobile application. Each computer 102 can be a desktop computer, laptop, tablet, or smartphone. Computers can be operable by a users affiliated with the HHA, HCP, or patient. In a preferred embodiment, computer 102 can communicate its location to server 101 and/or server 101 can ascertain the location of computer, using GPS, IP address, or other means of location determination known in the art. Network 103 can be a local area network (LAN), a wide area network (WAN), a piconet, or a combination of LANs, WANs, or piconets. One illustrative LAN is a network within a single business. One illustrative WAN is the Internet. In the preferred embodiment, network 103 will comprise the Internet.

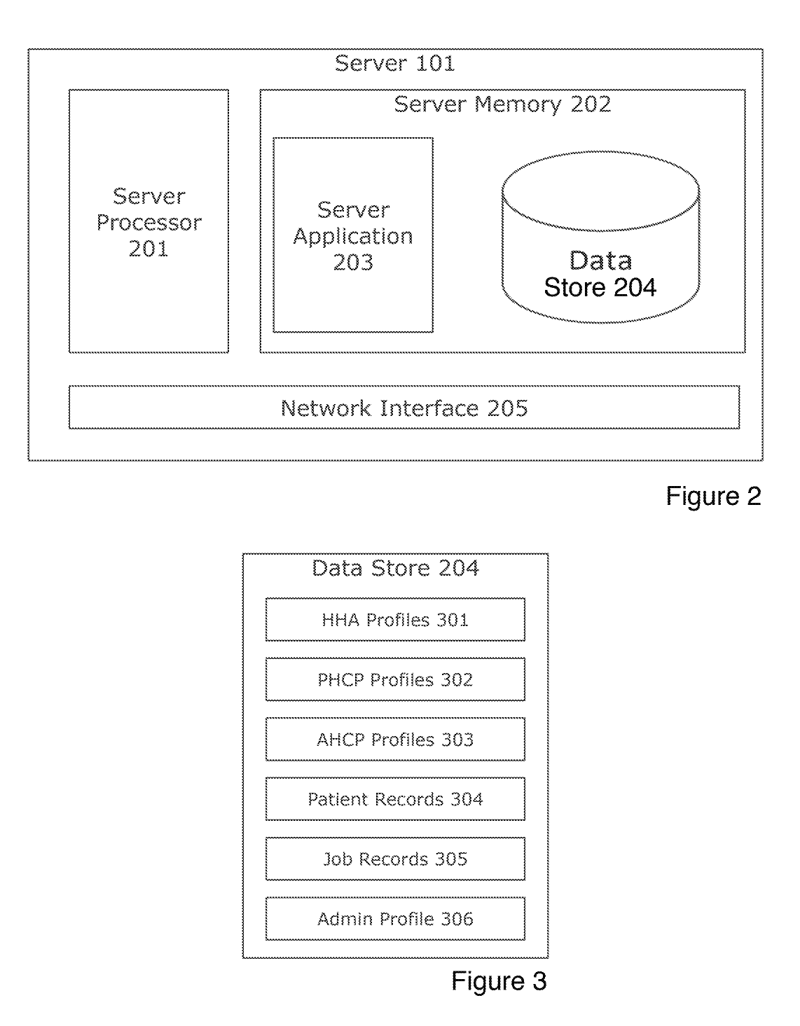

FIG. 2 illustrates a schematic diagram of server 101 according to an embodiment of the present disclosure. Server 101 can comprise a server processor 201, and a server memory 202 and a network interface 205. Network interface 205 can be a program that allows a user or computers 102 to interact with server 101. Server processor 201 can be a processing unit that performs set of instructions stored within server memory 202. Server memory 202 can comprise a server application 203, and a data storage 204. Data storage 204 can be collections of data accessible through server application 203. Server memory 202 can be local to server 101 and/or remote. Server application 203 can be business logic for server 101 executed by server processer. Server application 203 can be one or more applications. Further, server application 203 can perform functions such as adding, transferring, retrieving, and deleting information on data storage 204.

FIG. 3 illustrates data storage 204. Server application 203 is capable of linking one or more HHAs each with one or more HCPs. Within the context of this disclosure, an HCP can be either a primary health care provider (PHCP) or an assistant health care provider (AHCP). For purpose of this disclosure, a set of tasks related to a particular problem, performed by an HCP for a patient on behalf of the HHA, is referred to as a job. Data storage 204 can comprise one or more home health agency (HHA) profiles 301, one or more primary health care provider (PHCP) profiles 302, one or more assistant health care provider (AHCP) profiles 303, one or more patient records 304, and one or more job records 305. HHA profiles 301 can comprise data related to an HHA. PHCP profiles 302 can comprise data related to primary health care providers such as primary health care provider's name, account login information, specialization, location, and/or contact information. Examples of PHCPs can include but are not limited to physical therapists, speech therapists, registered nurses, and/or occupational therapists. AHCP profiles 303 can comprise information on assistant health care providers such as assistant health care provider's name, account login information, specialization, location, and/or contact information. Examples of AHCPs can include but are not limited to physical therapist assistants, speech therapist assistants, licensed vocational nurses (LVNs), and occupational therapist assistants. Job records 305 can comprise a health care service job posting created by an HHA. Job records 305 can comprise information such as name of patient, location and/or address of patient, contact information, injury of patient, and type of service or specialist needed, duration and/or frequency of treatment, assigned PHCP, assigned AHCP, and status of job posting. Admin profiles 306 can comprise one or more profiles belonging to an administrator of server application 203.

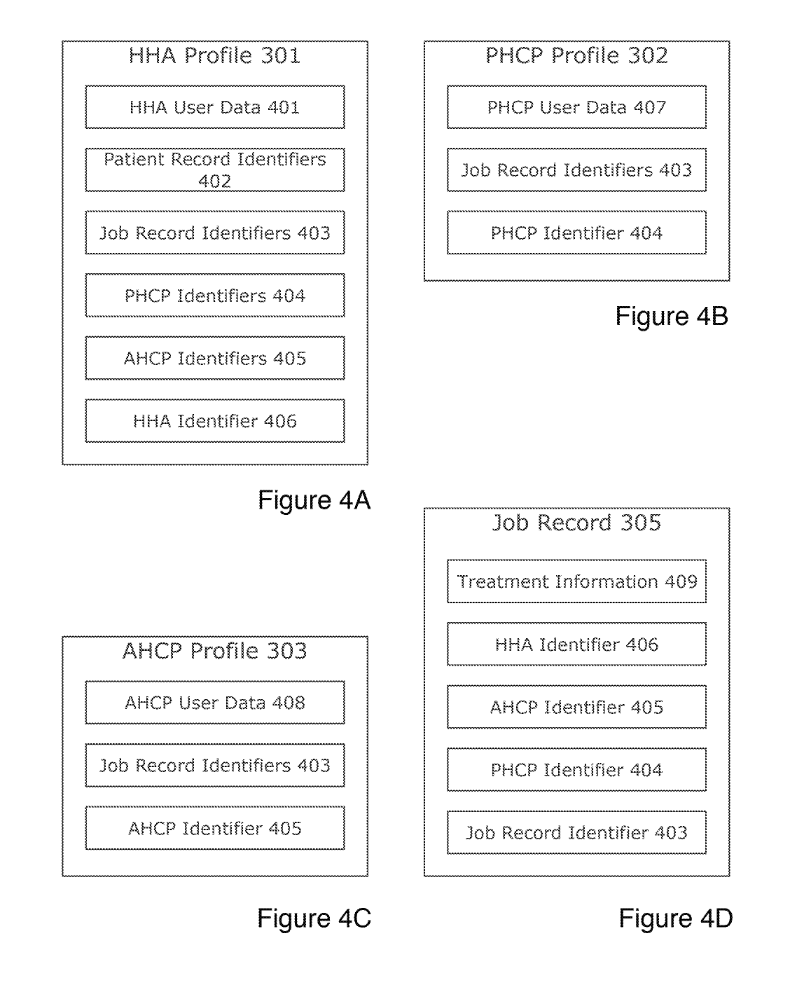

FIG. 4A illustrates home health agency (HHA) profile 301 comprising or otherwise associated with HHA user data 401, one or more patient record identifier 402, one or more job record identifiers 403, and/or PHCP identifiers 404. HHA user data 401 can include, but is not limited to the name of the agency, address, contact information, authorized users, login credentials, and/or billing information. In one embodiment, patient record identifiers 402 can link patient records 304 to particular HHA profiles 301. Patient record identifier 402 is unique identification information such as a patient account number, social security number, or randomly assigned string, related to a particular patient record 304, and that identifies the particular patient record 304. Similarly, job record identifier 403 can be unique identity information that identifies a particular job record 305. PHCP identifier 404 is unique identification information that identifies a particular PHCP profile 302. AHCP identifier 405 is unique identification information that identifies a particular assistant health care provider profile 303. HHA profile may, in one embodiment include PHCP identifiers 404 and AHCP identifier 405 related to preferred providers or excluded providers. It is understood by one of ordinary skill in the art a purpose of unique identifiers is to link sets of information in a database. Within the context of this disclosure, HHA profile, related to real-world relationships, can be linked to certain PHCP profiles 302, AHCP profiles 303, patient records, 304, and/or job records 305. For example, HHA profiles linked with certain job records 305 can view PHCP profiles 302 and AHCP profiles 303 linked to such job records 305. The linking of any information within data store 204 can occur using unique identifiers as described above or using any system or method known in the art.

FIG. 4B illustrates exemplary PHCP profile 302 comprising PHCP user data 407, job record identifiers 403, and PHCP identifier 404. PHCP user data 407 can include, but is not limited to the name of the PHCP, address, contact information, specialization such as physical therapist, registered nurse, occupational therapist, or speech therapist, authorized users, login credentials, and/or billing information. PHCP profile 302 can also comprise job record identifiers 403 relating to job records 305 associated with PHCP profile 302. PHCP identifier 404 is a unique identifier of PHCP profile 302 that distinguishes it from other PHCP profiles.

FIG. 4C illustrates exemplary AHCP profile 303 comprising AHCP user data 408, job record identifiers 403, and AHCP identifier 405. AHCP user data 408 can include, but is not limited to the name of the AHCP, address, contact information, specialization such as physical therapist assistant, licensed vocational nurse, occupational therapist assistant, or speech therapist assistant, authorized users, login credentials, and/or billing information. AHCP profile 303 can also comprise job record identifiers 403 relating to job records 305 associated with AHCP profile 303.

FIG. 4D illustrates job record 305 comprising HHA identifier 406, PHCP identifier 404, AHCP identifier 405, and job record identifier 403. HHA identifier 406 identifies HHA profiles 301 linked with job record 305. PHCP identifier 404 identifies PHCP profile 302 linked with job record 305. AHCP identifier 405 identifies AHCP profiles 303 linked with job records 305. Job records 305 also comprises treatment information 409, as will be described further.

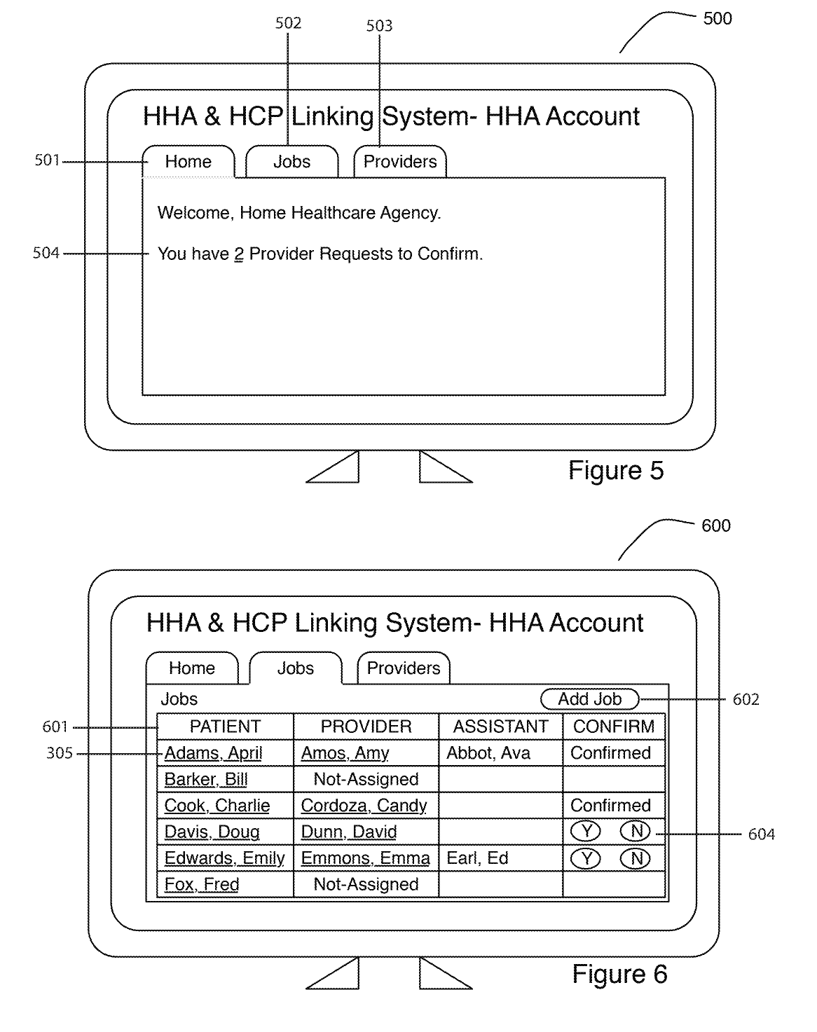

FIG. 5 illustrates an embodiment of an HHA home screen 500. As an example embodiment, an authorized user of HHA can access HHA and HCP linking system 100 by logging into their account within server application 203. Once successfully logged in, HHA can access HHA home screen 500. In one embodiment, HHA home screen 500 can comprise a graphical user interface (GUI) with components such as N, and a provider's tab 503, allowing a user to navigate to view data within or otherwise linked to HHA profiles 301. As an example, home tab 501 can display to HHA on computer 102 general information such as HHA notifications 504. Further as an example, HHA notification 504 can inform HHA if any HCP has accepted or confirmed any of the job postings under job records 305, the meaning of which will be described below. Further, in one embodiment, HHA notification 504 can show the list of HCPs that confirmed a job posting. Further, in one embodiment, HHA notification 504 can comprise a link. In such embodiment, clicking the link can connect HHA to data relevant to HHA notification 504.

FIG. 6 illustrates an embodiment of HHA's jobs screen 600. When a patient is referred to or otherwise contacts an HHA for a home health service, the HHA can, using server application 203, create a new job record 305 related to the patient and the service, as will be discussed further below. In an exemplary embodiment, clicking on jobs tab 502 can allow HHA to access HHA jobs screen 600. HHA jobs screen 600 can display on computer 102 operated by HHA treatment information 409 from job records 305 linked with HHA profiles 301. As an example, a jobs posting table list 601 can provide HHA a quick overview job postings. In one embodiment, HHA job screen 600 can display links that, when clicked cause additional information related to a particular job record 305 to be displayed. Jobs posting table list 601 can comprise treatment information 409 and other data from each jobs record 305 such as the patient, PHCP assigned to the patient, AHCP assigned to the patient, and job posting status of patients. Data displayed can be displayed with or as a link, allowing a user to click to retrieve additional data. For example, clicking a patient name can allow HHA to view patient records 304 or job record 305, while clicking a PHCP or AHCP assigned to patient can allow HHA to view PHCP profile 302 or AHCP profile 303, respectively. In one embodiment, HHA can be capable of accepting HCP's request to be assigned to a specific patient or job posting, which will be discussed further below. In such embodiment, an HHA can accept a request by clicking a confirm button 603 for the specific patient or job posting. As an example, once confirm button 603 is clicked, job posting status can be displayed as “Confirmed”. Further, add job button 602 can allow HHA to create a new job posting. The new job posting can be listed under job records 305.

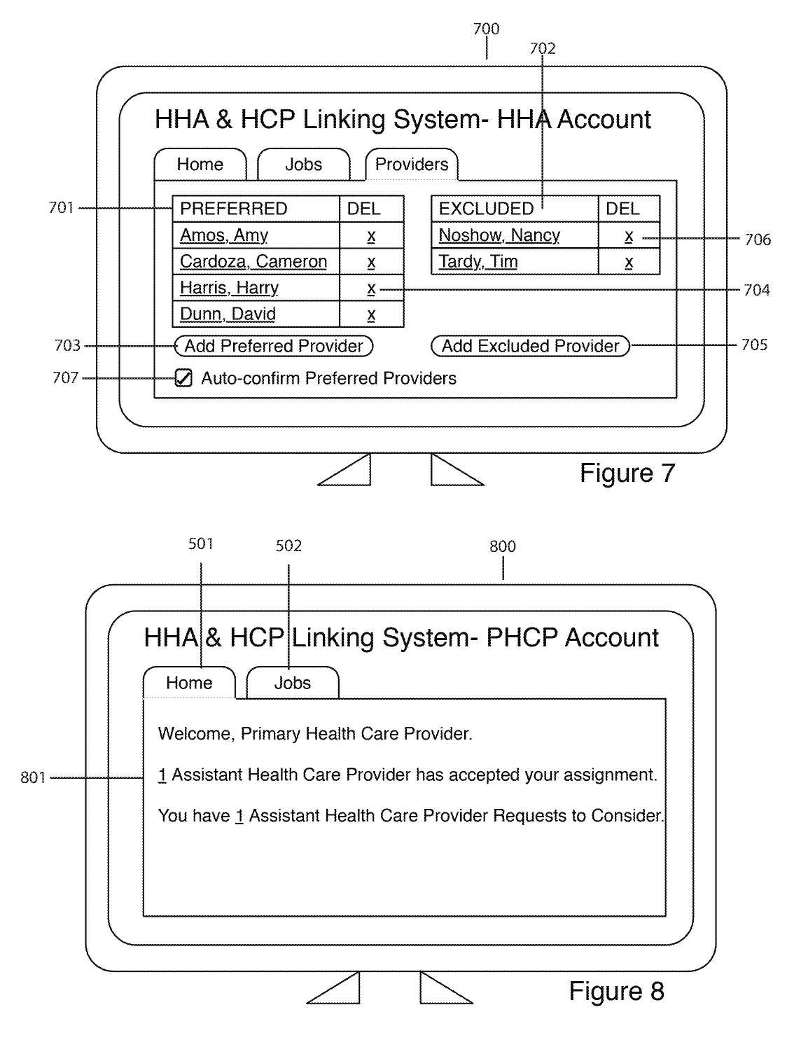

FIG. 7 illustrates an embodiment of HHA's providers screen 700. Clicking on providers tab 503 can allow HHA to access HHA providers screen 700. HHA providers screen 700 can comprise a list of preferred providers 701, a list of excluded providers 702, an add preferred provider button 703, a delete preferred provider button 704, an add excluded provider 705, a delete excluded provider button 706, and/or an auto-confirm preferred providers checkbox 707. In one embodiment, an HHA can add and remove PHCPs and AHCPs that are to be preferred by their HHA. As such, HCPs listed under preferred providers 701 can be given preferential privileges in assignments, while HCPs listed under excluded providers 702 may not be notified and/or would be excluded from applying for jobs relating to job records 305 associated with related HHA profiles 301. Clicking add preferred provider button 703 can allow HHA to add a specific HCP under preferred providers 701. Clicking delete preferred provider button 704 can allow HHA to remove a specific HCP under preferred providers 701. Clicking add excluded provider button 705 can allow HHA to add a specific HCP under excluded providers 702. Clicking delete excluded provider button 706 can allow HHA to add a specific HCP under excluded providers 702. A check on auto-confirm preferred providers checkbox 707 can allow HHA and HCP linking system 100 to automatically confirm job listing assignments to HCPs listed under preferred providers 701. Such feature eliminates the need for HHA to click confirm button 603 for each job listing that are accepted by preferred providers.

FIG. 8 illustrates an embodiment of PHCP home screen 800 comprising home tab 501, and jobs tab 502. In one embodiment, to access PHCP home screen 800, PHCP can first access HHA and HCP linking system 100 and enter his PHCP account login information. Once logged in, PHCP can access PHCP home screen 800. In one embodiment, PHCP home screen 800 can comprise a graphical user interface (GUI) with components such as home tab 501, and jobs tab 502, allowing a PHCP to navigate to view data within or otherwise linked to PHCP profile 302. As an example, home tab 501 within PHCP home screen 800 can display on computer 102 operated by PHCP general information such as PHCP notifications 801. Further as an example, PHCP notification 801 can inform PHCP if any AHCP has accepted an assignment from PHCP, the meaning of which will be described below. Further, in one embodiment, PHCP notification 801 can show requests from AHCP. Further, in one embodiment, PHCP notification 801 can comprise a link. In such embodiment, clicking the link can connect PHCP to data relevant to PHCP notification 801.

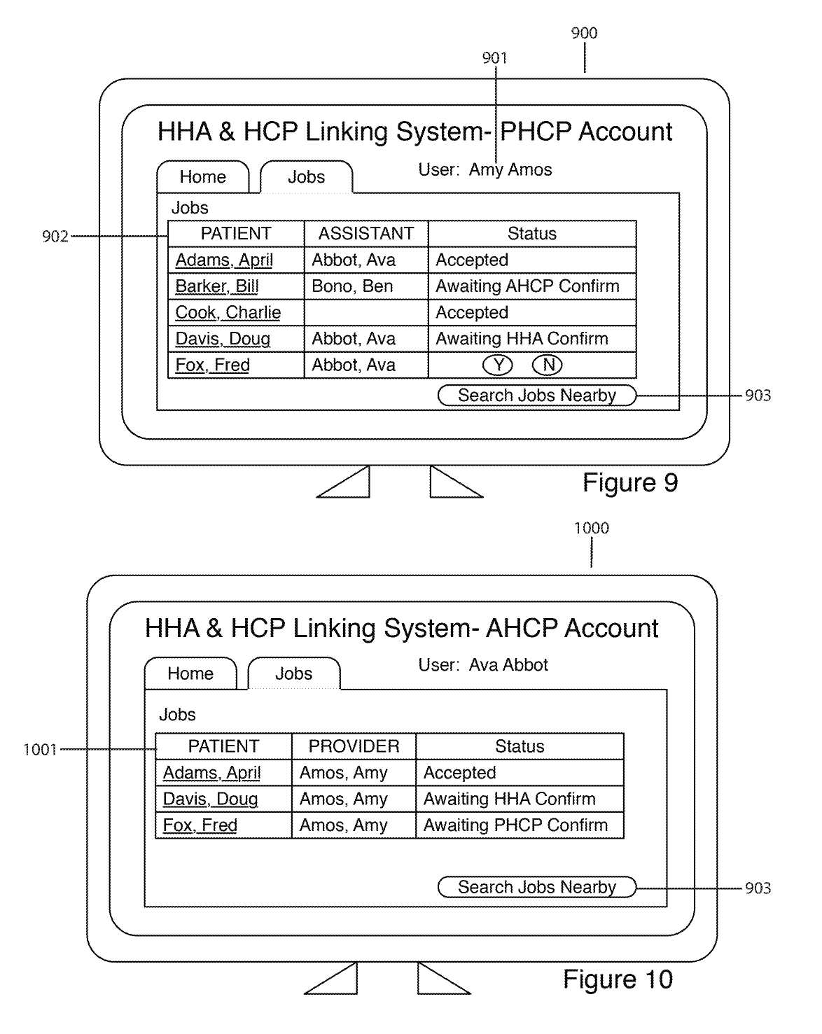

FIG. 9 illustrates an embodiment of PHCP job screen 900 comprising a currently signed in user 901, PHCP jobs table list 902, and a search jobs nearby button 903. When an HHA creates job record 305, a PHCP can accept a treatment request within job record 305 alone or with an AHCP, as will be discussed further below. In doing so, job record 305 becomes linked with PHCP profile 302 in data store 204 such that when PHCP logs into PHCP profile 302, PHCP has access to view, add to, and/or edit job record 305, subject to permission settings. In an exemplary embodiment, clicking on jobs tab 502 can allow PHCP to access HHA jobs screen 600. PHCP Jobs screen 900 for PHCP profile 302 can display on computer 102 treatment information 409 and other data from job records 305 linked with PHCP profile 302. As an example, a jobs posting table list 601 on PHCP job screen 900 can provide PHCP a quick overview of job postings. In one embodiment, PHCP job screen 900 can display links that, when clicked cause additional information related to a particular job record 305 to be displayed. Jobs posting table list 601 can comprise data from each jobs record 305 such as the patient, AHCP assigned to the patient, and job posting status of patients. Data can be displayed with or as a link, allowing a user to click to retrieve additional data. For example, clicking a patient name can allow PHCP to view patient records 304 and/or job record 305, while clicking an AHCP assigned to patient can allow PHCP to view AHCP profile 303, respectively. In one embodiment, PHCP can view statuses of jobs such as when a job has been accepted, is awaiting confirmation from PHCP, AHCP, or HHA. In one embodiment, PHCP can accept AHCP's request to be assigned to a specific patient or job posting, which will be discussed further below. In such embodiment, PHCP can accept a request by clicking a confirm button 603 for the specific patient or job posting. In one embodiment wherein no HHA confirmation is necessary, once confirm button 603 is clicked, job posting status can be displayed as “Confirmed”. In another embodiment wherein HHA confirmation is necessary, job posting status can be displayed as “Awaiting HHA Confirm” or some other similar message. Further, clicking search jobs nearby button 903 can allow PHCP to find available job listings or job records 305 within his area, as will be discussed further below.

FIG. 10 illustrates an embodiment of AHCP jobs screen 1000 comprising currently signed in user 901, AHCP jobs table list 1001, and search jobs nearby button 903. When an HHA creates job record 305, an AHCP can accept a treatment request within job record 305 as an assistant to a PHCP, as will be discussed further below. In doing so, job record 305 becomes linked with AHCP profile 303 in data store 204 such that when AHCP logs into AHCP profile 303, AHCP has access to view, add to, and/or edit job record 305, subject to permission settings. In an exemplary embodiment, clicking on jobs tab 502 can allow AHCP to access AHCP jobs screen 1000. AHCP jobs screen 1000 within AHCP profile 303 can display treatment information 409 and other data from job records 305 linked with AHCP profile 303. As an example, a jobs posting table list 601 on AHCP job screen 1000 can provide AHCP a quick overview of job postings. In one embodiment, AHCP job screen 1000 can display links that, when clicked cause additional information related to a particular job record 305 to be displayed. Jobs posting table list 601 for AHCP can comprise data from each jobs record 305 such as the patient, PHCP assigned to the patient, and job posting status of patients. Data can be displayed with or as a link, allowing a user to click to retrieve additional data. For example, clicking a patient name can allow AHCP to view patient records 304 and/or job record 305, while clicking a PHCP assigned to patient can allow AHCP to view PHCP profile 302, respectively. In one embodiment, AHCP can view statuses of jobs such as when a job has been accepted, is awaiting confirmation from PHCP, AHCP, or HHA. In one embodiment, AHCP can accept PHCP's request for AHCP to accept a request to assist on a treatment request in a job posting, which will be discussed further below. In such embodiment, AHCP can accept a request by clicking a confirm button 603 for the specific patient or job posting, similar to one as shown in FIG. 9. In one embodiment wherein no HHA confirmation is necessary, once confirm button 603 is clicked, job posting status can be displayed as “Confirmed”. In another embodiment wherein HHA confirmation is necessary, job posting status can be displayed as “Awaiting HHA Confirm,” or some other similar message. In an embodiment wherein AHCP requests a job, it will be contingent upon PHCP confirmation. In such embodiment, job posting status can read “Awaiting PHCP Confirm,” or some other similar message. Further, clicking search jobs nearby button 903 can allow AHCP to find available job listings or job records 305 within his area, as will be discussed further below.

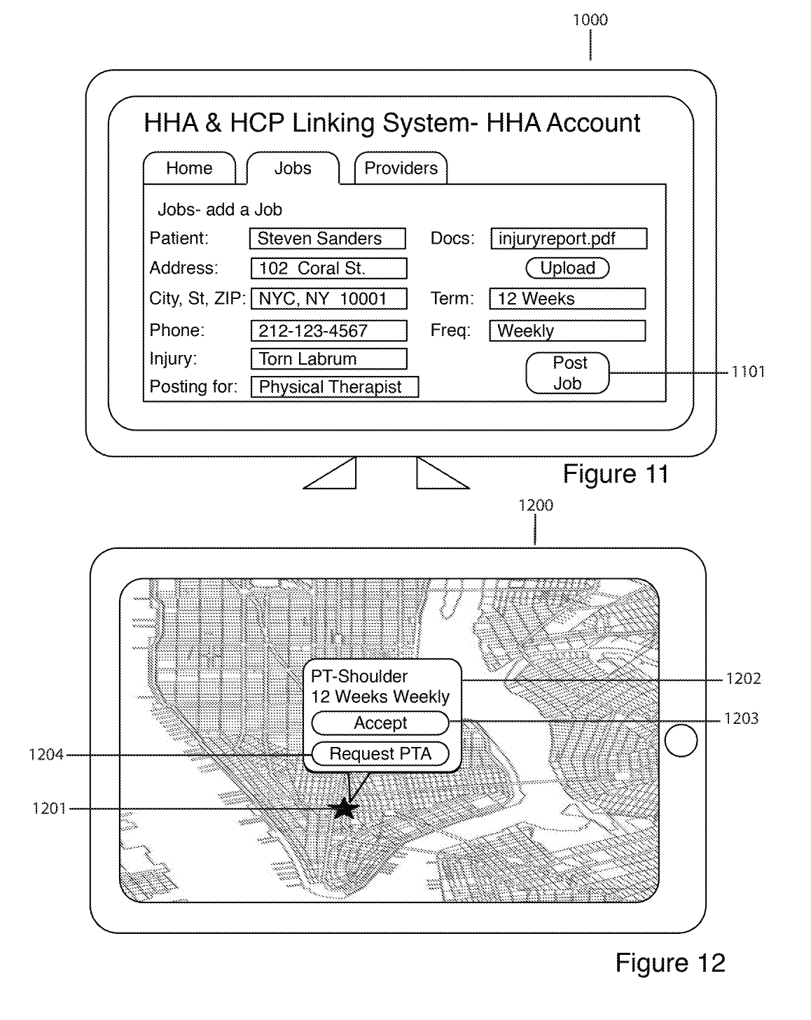

FIG. 11 illustrates an embodiment of an add job screen 1100. After an HHA receives a patient referral, HHA can click add job button 602 on HHA's jobs screen 600 to access add job screen 1100. Add job screen 1100 allows HHA to create a new job record using a form in one embodiment. As an example, the form can capture treatment information 409 such as but not limited to a patient's name, patient's address, patient's contact number, patient's injury, service/s and/or treatment request, file attachment (such as x-rays, medical files, etc.), duration of therapy, frequency of therapy, and a post job button 1101. HHA can fill out form and click post job button 1101 to create a new job records 305. In one embodiment, when new job record 305 is created, a notification can be sent to PHCP profiles and AHCP profiles running on computers 102 geographically within a predetermined threshold of the patient's address within new job record 305. The notification, in one embodiment, can create an alert on the PHCP or AHCP's computer 102 such as a ringtone, vibration, or visible notification on screen. Such visible notification can be a clickable link that takes PHCP or AHCP to see job record 305. In another embodiment, job record 305 can be searchable by PHCPs and/or AHCPs irrespective of their immediate location.

FIG. 12 illustrates an embodiment of a system map 1200 viewable by a PHCP on computer 102. A system map 1200 can be a map generated by HHA and HCP linking system 100 displayable to HHAs, PHCPs, and AHCPs. System map 1220 can comprise one or more icons 1201, and job information 1202. Each job postings added by an HHA under HHA job screen 600 can be plotted as icons 1201 on system map 1200 by server application 203. Once added, icons 1201 can be displayed on system map 1200. Moreover, PHCPs and AHCPs that are preferred by HHA can view icons 1201 on system map 1200 in real-time. Job information 1202 can also be displayed when a user hovers or clicks on a specific icon 1201. Job information 1202 can include information such as a treatment request, frequency and duration of treatment. In this embodiment wherein a PHCP is logged in and viewing system map 1200, job information 1202 can comprise an accept button 1203 and an AHCP button 1204. A PHCP can choose to accept the job posting by clicking accept button 1203. In one embodiment wherein PHCP is listed under preferred provider 701 of the listing HHA and auto-confirm preferred providers checkbox is clicked, as soon as the said preferred PHCP clicks accept button 1203, the specific job posting will be automatically assigned to him. In one embodiment wherein HHA authorization is required, an HHA would need to review and confirm a PHCP's acceptance if the PHCP is not under the HHA's list of preferred providers 701. In another embodiment, HHA authorization is not required for any PHCP. Further in another embodiment, PHCP can accept a specific job posting on a condition that his preferred or chosen AHCP also accepts the said job posting. As an example of such system, FIG. 12 shows an AHCP button 1204 clickable by PHCP. Upon clicking AHCP, server application 203, via a GUI, can allow PHCP to identify an AHCP. Such AHCP can then be notified via server application 203 and given an option to accept or reject the treatment request. In one embodiment, HHA would only be notified that PHCP has accepted the specific job posting once the PHCP's selected AHCP has accepted said job posting. Further, icon 1201 related to such job record 305 would remain visible and selectable by other HCPs until job record 305 is accepted by a PHCP and contingent AHCP if any.

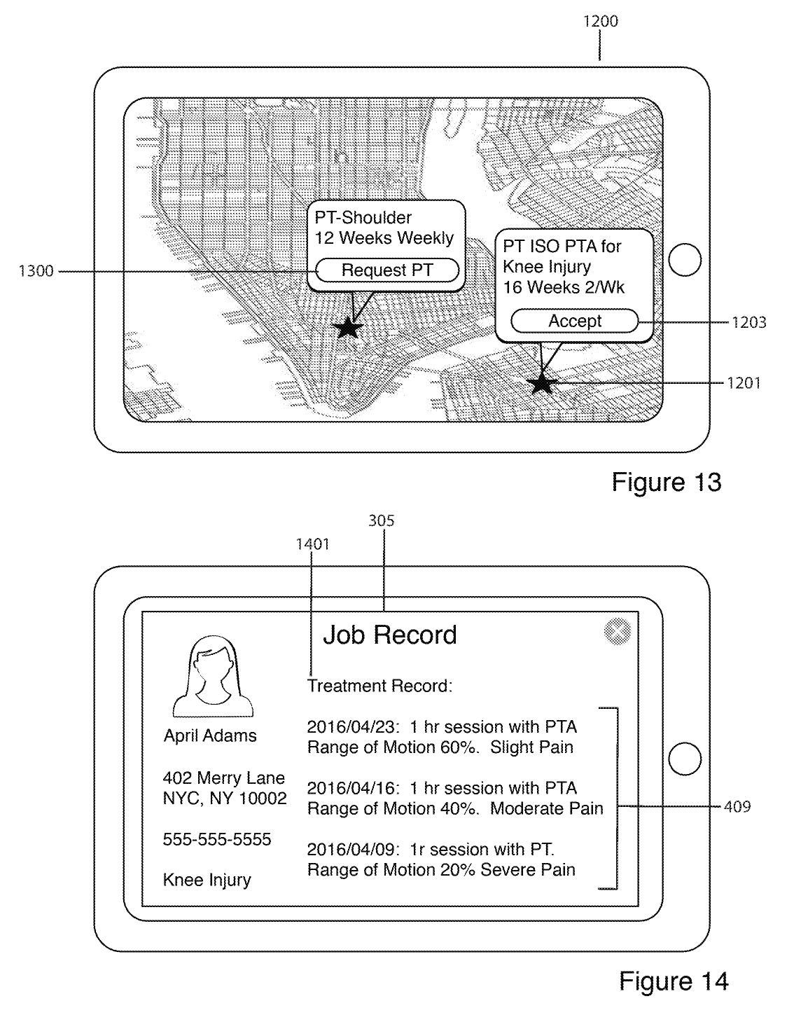

FIG. 13 illustrates an embodiment of a system map 1200 as viewed by an AHCP on computer 102. The AHCP viewing system map 1200 can view available job postings made by HHA but does not have an option to accept a job. Instead, AHCP can click on a request provider button 1300 in order to request for a conditional acceptance to a specific PHCP. In such scenario, the specific PHCP user selected by the AHCP can receive an AHCP notification 1301. In one embodiment, conditional acceptance request sent by the AHCP can be displayed on the specific HCP home screen 800 as request assignment link 802. In a scenario wherein the specific PHCP rejects the AHCP's request, the AHCP who sent the conditional acceptance can be notified that his request was rejected. Further, job posting can be available for other AHCP until the PHCP assigned to the said job posting accepts or confirms one of the AHCP.

In another scenario, PHCP could accept a treatment request without assistance from an AHCP, but later decide to solicit assistance from an AHCP, as shown in FIG. 13. An AHCP viewing map 1200 can see icons related to job record 305 already linked with a PHCP. In such instance, AHCP can click accept button 1203.

FIG. 14 illustrates treatment information 409 of job record 305 viewable by users of linking system 100. In one embodiment, treatment information 409 can comprise a treatment record 1401 fillable and editable by HHAs, PHCPs and/or AHCPs. For example, when a physical therapist initially visits a patient, the physical patient can make notes and device a treatment plan, which in one embodiment can be recorded in treatment information. Further, if a physical therapist assistant is responsible for later treatments, the physical therapist assistant can view treatment plan within treatment information 409, and add new notes related to subsequent visits, as shown in FIG. 14.

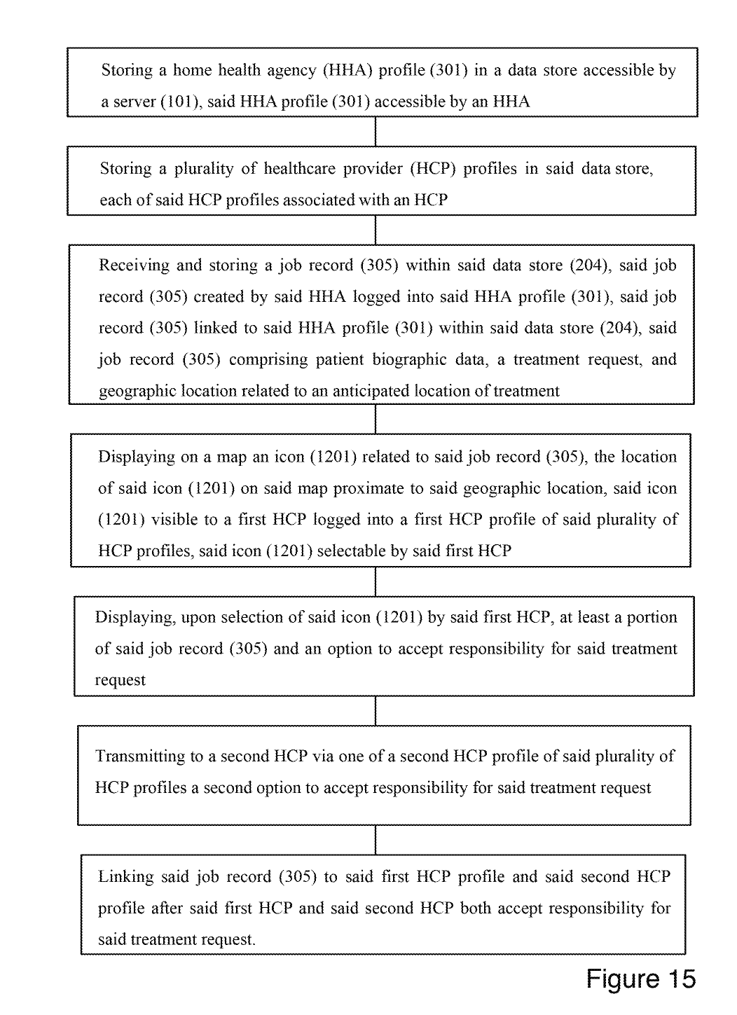

FIG. 15 illustrates an exemplary method. The method can comprise the steps of storing HHA profiles 301, storing a plurality of healthcare provider profiles, and receiving and storing a job record 305 within data store 204. HHA profiles 301 can be accessible by server 101. Further, HHA profiles 301 can be accessible by an HHA. Each of the HCP profiles can be associated with an HCP. Job record 305 can be created by the HHA logged in to HHA profile 301. Job record 305 can be linked to HHA profile within data store 204. Further, job record 305 can comprise patient biographic data, a treatment request, and geographic location related to an anticipated location of treatment. Moreover the step can comprise displaying on a map icon 1201 related to job record 305, the location of the icon on the map proximate to the geographic location. Icon 1201 can be visible to a first HCP logged into a first HCP profile of the plurality of HCP profiles. The icon can be selectable by the first HCP. The step can also comprise displaying, upon selection of the icon by the first HCP, at least a portion of job record 305 and an option to accept responsibility for the treatment request. Additionally, the step can comprise transmitting to a second HCP via one of a second HCP profile of the plurality of HCP profiles a second option to accept responsibility for said treatment request. Lastly, the method can comprise linking job record 305 to the first HCP profile and the second HCP profile after the first HCP and the second HCP both accept responsibility for said treatment request.

It is understood that there can be other applications that are stored in server memory 202 and are executable by server processor 201 as can be appreciated. Where any component discussed herein is implemented in the form of software, any one of a number of programming languages can be employed such as, for example, C, C++, C#, Objective C, Java, Java Script, Perl, PHP, Visual Basic, Python, Ruby, Delphi, Flash, or other programming languages.

A number of software components can be stored in server memory 202 and can be executable by server processor 201. In this respect, the term “executable” means a program file that is in a form that can ultimately be run by server processor 201. Examples of executable programs can be, for example, a compiled program that can be translated into machine code in a format that can be loaded into a random access portion of server memory 202 and run by server processor 201, source code that can be expressed in proper format such as object code that is capable of being loaded into a random access portion of server memory 202 and executed by server processor 201, or source code that can be interpreted by another executable program to generate instructions in a random access portion of provider memory 202 to be executed by server processor 201, etc. An executable program can be stored in any portion or component of server memory 202 including, for example, random access memory (RAM), read-only memory (ROM), hard drive, solid-state drive, USB flash drive, memory card, optical disc such as compact disc (CD) or digital versatile disc (DVD), floppy disk, magnetic tape, network attached/addressable storage or other memory components.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A method for linking home health agencies (HHAs) and health care providers (HCPs) over a network comprising
storing a home health agency (HHA) profile in a data store accessible by a server, said HHA profile accessible by an HHA;
storing a plurality of healthcare provider (HCP) profiles in said data store, each of said HCP profiles associated with an HCP;
receiving and storing a job record within said data store, said job record created by said HHA logged into said HHA profile, said job record linked to said HHA profile within said data store, said job record comprising patient biographic data, a treatment request, and geographic location related to an anticipated location of treatment;
displaying on a map an icon related to said job record, the location of said icon on said map proximate to said geographic location, said icon visible to a first HCP logged into a first HCP profile of said plurality of HCP profiles, said icon selectable by said first HCP;
displaying, upon selection of said icon by said first HCP, at least a portion of said job record and an option to accept responsibility for said treatment request;
transmitting to a second HCP via one of a second HCP profile of said plurality of HCP profiles a second option to accept responsibility for said treatment request; and
linking said job record to said first HCP profile and said second HCP profile after said first HCP and said second HCP both accept responsibility for said treatment request.

2. The method of claim 1 wherein said first HCP profile is a primary health care provider (PHCP) profile, and said second HCP profile is an assistant health care provider (AHCP) profile.

3. The method of claim 2 wherein said PHCP is a physical therapist, and said AHCP is a physical therapist assistant.

4. The method of claim 2 wherein said PHCP is an occupational therapist, and said AHCP is an occupational therapist assistant.

5. The method of claim 2 wherein said PHCP is a speech therapist, and said AHCP is a speech therapist assistant.

6. The method of claim 2 wherein said PHCP is a registered nurse, and said AHCP is a licensed vocational nurse.

7. The method of claim 1 wherein before linking said job record to said first HCP profile and said second HCP profile, and after said first HCP and said second HCP both accept responsibility for said treatment request, comprising the additional step of receiving approval from said HHA via said HHA profile.

8. The method of claim 7 wherein approval from said HHA is received automatically if said first HCP profile or said second HCP profile is linked to said HHA profile as a preferred provider.

9. The method of claim 7 wherein approval from said HHA is received automatically if said first HCP profile and said second HCP profile are both linked to said HHA profile as a preferred provider.

10. A system that links home health agencies (HHAs) with health care providers (HCPs) comprising
a server memory that stores
a home health agency (HHA) profile accessible by a server, said HHA profile accessible by an HHA;
one or more primary healthcare provider (PHCP) profiles, each of said HCP profiles associated with an HCP;
one or more patient records;
one or more job records, each of said job records created by said HHA logged into said HHA profile, each of said job records linked to said HHA profile, further wherein each of said job record comprising patient biographic data, a treatment request, and geographic location related to an anticipated location of treatment; and
a server application; and
a server processor that, according to the instructions from said server application
displays on a map an icon related to one of said job records, the location of said icon on said map proximate to said geographic location, said icon visible to a first HCP logged into a first HCP profile of said plurality of HCP profiles, said icon selectable by said first HCP;
displays, upon selection of said icon by said first HCP, at least a portion of said one of said job records and an option to accept responsibility for said treatment request;
transmits to a second HCP via one of a second HCP profile of said plurality of HCP profiles a second option to accept responsibility for said treatment request; and
links said one of said job record to said first HCP profile and said second HCP profile after said first HCP and said second HCP both accept responsibility for said treatment request.

11. The system of claim 10 wherein said first HCP profile is a primary health care provider (PHCP) profile, and said second HCP profile is an assistant health care provider (AHCP) profile.

12. The system of claim 11 wherein said PHCP is a physical therapist, and said AHCP is a physical therapist assistant.

13. The system of claim 11 wherein said PHCP is an occupational therapist, and said AHCP is an assistant occupational therapist.

14. The system of claim 11 wherein said PHCP is a speech therapist, and said AHCP is an assistant speech therapist.

15. The system of claim 11 wherein said PHCP is a registered nurse, and said AHCP is a licensed vocational nurse.

16. The system of claim 10 wherein before linking said job record to said first HCP profile and said second HCP profile, and after said first HCP and said second HCP both accept responsibility for said treatment request, comprising the additional step of receiving approval from said HHA via said HHA profile.

17. The system of claim 16 wherein approval from said HHA is received automatically if said first HCP profile or said second HCP profile is linked to said HHA profile as a preferred provider.

18. The system of claim 16 wherein approval from said HHA is received automatically if said first HCP profile and said second HCP profile are both linked to said HHA profile as a preferred provider.

19. A non-transitory computer readable storage medium having a computer readable program code embodied therein, wherein the computer readable program code is adapted to be executed to implement the method of claim 1.
